(19) United States
(12) Patent Application Publication
(10) Pub. No.: US 2025/0269210 A1
(43) Pub. Date: Aug. 28, 2025

(54) DEVICE AND METHOD FOR OPENING A LOCKED PUBLIC DOOR HAVING A PANIC BAR FROM THE OUTSIDE AND ASSOCIATED KIT

(71) Applicant: F21 Solutions LLC, Sheridan, WY (US)

(72) Inventor: Joseph BENTLEY, Priest River, ID (US)

(21) Appl. No.: 19/063,468

(22) Filed: Feb. 26, 2025

Related U.S. Application Data
(60) Provisional application No. 63/557,841, filed on Feb. 26, 2024.

(51) Int. Cl. A62B 3/00; E05B 65/10

(52) U.S. Cl. CPC A62B 3/005; E05B 65/1046

(57) ABSTRACT

A door-opening device for use when breeching public doors with interior panic bars during an emergency, the device comprising an elongated pivotable shaft having a handle with a trigger disposed at a first end and a tip disposed at a second end, the pivotable shaft comprising: a proximal section connected to the handle and having an internal cavity; and, a distal section having the tip, the proximal section hingedly connected to the distal section opposite the handle and the distal section hingedly connected to the proximal section opposite the tip, a plunger arranged within the internal cavity and connected to the trigger, the trigger adapted to selectively translate the plunger within the internal cavity to engage or disengage the distal section to allow the distal section to pivot about the proximal section. A kit comprising the door-opening device and a method of use is also disclosed.

### CROSS-REFERENCE RELATED APPLICATIONS

This application claims priority under 35 U.S.C. § 119(e) to U.S. Provisional Patent Application No. 63/557,841, filed Feb. 26, 2024, which application is incorporated by reference herein in its entirety.

### FIELD

The field of this invention relates generally to the field of methods and devices for emergency opening of public doors from the outside and more particularly towards use with doors that are equipped with a panic bar, or similar hardware, on the inside.

### BACKGROUND

In the event of emergency, whether it be a fire or a crime in progress such as an active shooter, in a public building, time is of the essence to get into the building and resolve the situation. One impediment to resolving issues is the time it takes to get inside of a public building that may have hazards inside such as a shooter or shooters in unknown locations.

When dealing with an active shooter or hostage situation, not only is time of the essence, the highest degree of stealth is also preferable. Noise that can be produced by brute-force forced-entry devices when being used, not only alerts the shooter to impending entry, but can also increase the shooter's stress levels, thereby amplifying the danger of the situation—putting not only individuals inside the premise at a greater risk but also increasing the risk of the first responders attempting to gain entry.

In the event of a theater, for example, there is one way in but no way to know where the threat is when entering that way, especially when in the melee there could be a mob of people exiting the only way in.

Utilizing the theater example, there are other doors for exiting that are typically not accessible from the outside, i.e., a key is required to open from the outside or they can be opened from the inside, using a panic bar due to ADA codes.

In one attempt to solve the aforementioned issues, U.S. Pat. No. 7,004,051, granted Feb. 28, 2006, contemplates a J-hook, or a J-shaped rod, that can be inserted through the door and then manipulated until it is through the door (the inside) and further manipulated until the J-hook can contact the panic hardware in order to impart a “pushing force,” vis-à-vis a pull by a user on the outside, thereby actuating the panic hardware to open the door from the inside. This solution—although better than a noisy “brute-force” option, which can alert an individual inside the premise—has further problems. First, the shape of the device makes the necessary manipulation more time consuming, not only to effectively insert the device through the door, but to also contact the panic hardware, which adds additional time to the process. Second, the shape of the device also makes it more difficult for a first-time user to effectively and efficiently utilize the device, as a straight rod is much easier to insert through two apertures within two spaced-apart surfaces. The '051 patent is incorporated by reference herein in its entirety.

Other attempts to solve the aforementioned problems, such as U.S. Patent Application Publication No. 2012/0011968, filed Jul. 17, 2020, and U.S. Pat. No. 7,255,023, granted Aug. 14, 2007, contemplate devices that can be slid underneath a door. These devices are restricted to use with doors that have adequate space between the bottom of the door and the ground-level surface, and if a particular locked door has the required space, there could be an object, such as flooring or a weather-strip, that would prevent successful use of one or more of these devices to open the locked door. The '968 patent application publication and the '023 patent are incorporated by reference herein in their entireties.

Therefore, there is a long-felt need for a device and method for opening a locked public door having a panic bar from the outside, which device not only can open the locked door in a quick and efficient manner, but is substantially silent during use, has a straight configuration making it easier to be inserted through a pair of apertures through the locked public door but also bends to a hard 90-degree angle when needed (to actuate the panic hardware), thereby greatly improves the response time and effectiveness of opening a locked public door having panic hardware from the outside.

### SUMMARY OF THE INVENTION

The basic embodiment of the present invention teaches an improved door-opening device that is stiff and selectably bends to a hard 90-degree angle when needed, which greatly improves the response time and effectiveness of the method and device defined herein solving the aforementioned problems in a quicker, more efficient manner, while also being substantially silent.

In one possible embodiment, the present invention may comprise a device to breach a locked public door with an interior panic bar, the device having an elongated shaft with a break in the center, said elongated shaft have a first end and a second end wherein the first end has a pointed center and said second end has a handle and a lever, the lever extending through an interior portion of the elongated shaft and being spring loaded to either lock or selectably unlock the first end and the break in the center to either lock the elongated shaft as a straight bar or as a bent bar having a 90° angle.

In other possible aspects, the present invention may comprise a door-opening device adapted to open a locked public door with an interior panic bar from the outside of the public door, the device including an elongated pivotable shaft having a handle with a trigger disposed at a first end and a tip disposed at a second end, the pivotable shaft comprising: a proximal section connected to the handle and having an internal cavity; and, a distal section having the tip, the proximal section hingedly connected to the distal section opposite the handle and the distal section hingedly connected to the proximal section opposite the tip, a plunger arranged within the internal cavity and connected to the trigger, the trigger adapted to selectively translate the plunger within the internal cavity to engage or disengage the distal section to allow the distal section to pivot about the proximal section.

In some embodiments of the aforementioned door-opening device the proximal section comprising a slot formed by a pair of extensions and being arranged opposite the handle, each of the pair of extensions having a pin aperture therein, the distal section comprising a connection end defined by a pair of notches and being arranged opposite the tip, the connection end having a pin through-bore disposed between respective faces of the pair of notches, and the door opening device may further comprise a pin arranged within each of the pin apertures and the pin through-bore to hingedly connect the distal section to the proximal section.

In other embodiments, the aforementioned connection end may have a locking aperture disposed therein and arranged perpendicularly to the pin through-bore, the locking aperture arranged to accept a locking end of the plunger therein, thereby locking the distal section and the proximal section in a straight-bar configuration.

In further embodiments, the aforementioned connection end may also have a locking through-bore disposed therein and arranged perpendicularly to both the pin through-bore and the locking aperture, the locking through-bore arranged to accept the locking end of the plunger therein, thereby locking the distal section and the proximal section in a 90° angle.

In other possible configurations of the aforementioned door-opening device, the connection end having a locking aperture disposed therein and arranged perpendicularly to the pin through-bore, the connection end having a locking through-bore disposed therein and arranged perpendicularly to both the pin through-bore and the locking aperture, wherein either the locking aperture or the locking through-bore is arranged to accept a locking end of the plunger therein, allowing the pivotable shaft to be selectively oriented in either a straight-bar configuration or a bent-bar configuration, the bent-bar configuration having a 90° angle.

In further configurations, one or more of the aforementioned door-opening devices may further comprise a spring engaged with the plunger and the internal cavity adapted to bias the plunger within the internal cavity towards the distal section.

In other aspects, the present invention relates to a kit for opening a locked public door with an interior panic bar from the outside of the public door, the kit comprising one of the aforementioned door-opening devices, a step drill bit having a multi-diameter flute, and a rigid case.

In some embodiments of the kit for opening a locked public door with an interior panic bar from the outside of the public door, the flute of the step drill bit has an overall length that is greater than an overall width between an interior surface and an exterior surface of the locked public door.

In some embodiments of the kit for opening a locked public door with an interior panic bar from the outside of the public door the rigid case has an overall length that is greater than a mounting height of the interior panic bar on the locked public door.

In other embodiments of the kit for opening a locked public door with an

interior panic bar from the outside of the public door, one or more of: the flute of the step drill bit has an overall length that is greater than an overall width between an interior surface and an exterior surface of the locked public door; or, the rigid case has an overall length that is greater than a mounting height of the interior panic bar on the locked public door.

In further aspects, the present invention may also provide for a method for breaching a locked public door with an interior panic bar from the outside of the door, the method comprising:
1. drilling at least one hole through the locked public door, the at least one hole being above the interior panic bar of the door;
2. inserting the elongated shaft of the door-opening device recited in claim 20 into the at least one hole as the straight bar;
3. unlocking the lever of the elongated shaft and locking the lever of the elongated shaft into the bent bar;
4. pulling the elongated shaft away from the door to contact the interior panic bar; and,
5. applying force onto the interior panic bar to unlock the public door.

It is the object of the instant invention to provide a device and method of use that allows first responders to breach a locked public door from the outside when the locked public door is equipped with a panic bar on the inside, which nearly all are due to ADA codes.

It is a further object of the instant invention to provide a device and method of use that can be accessed in a short time, i.e., less than 20 seconds.

It is a still further object of the instant invention to provide a device and method of use that will automatically allow for the breach at a level that will quickly and easily access a panic bar on the inside.

It is an even further object of the instant invention to provide a means of repairing minimal damage to the public door after breach such that replacement of the door can be unnecessary.

These and other objects, features, and advantages of the present invention will become readily apparent upon a review of the following detailed description of the invention, in view of the drawings and appended claims.

### BRIEF DESCRIPTION

Various embodiments are disclosed, by way of example only, with reference to the accompanying schematic drawings in which corresponding reference symbols indicate corresponding parts, in which:

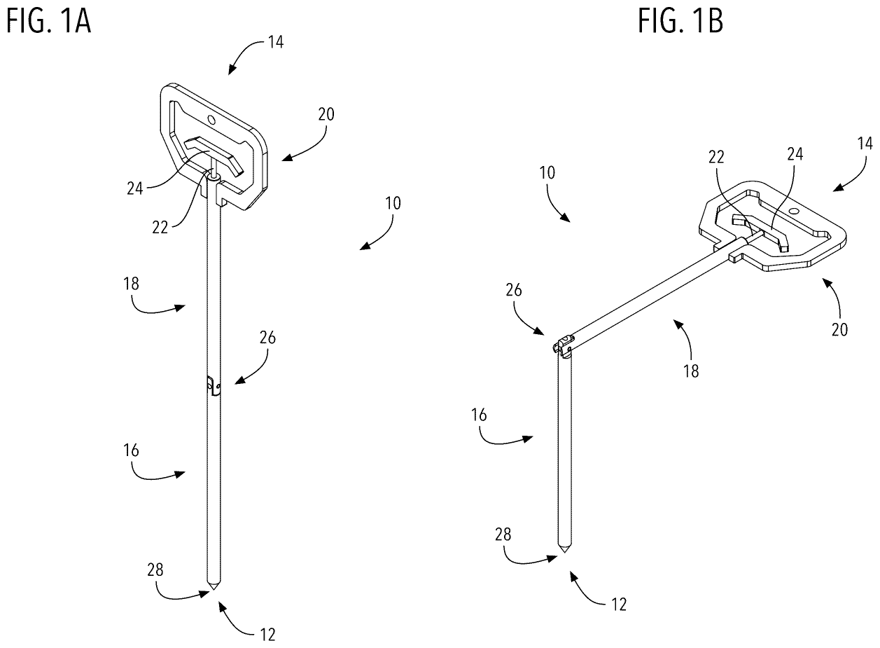

FIGS. 1A and 1B are a perspective views of an embodiment of a door opening device;

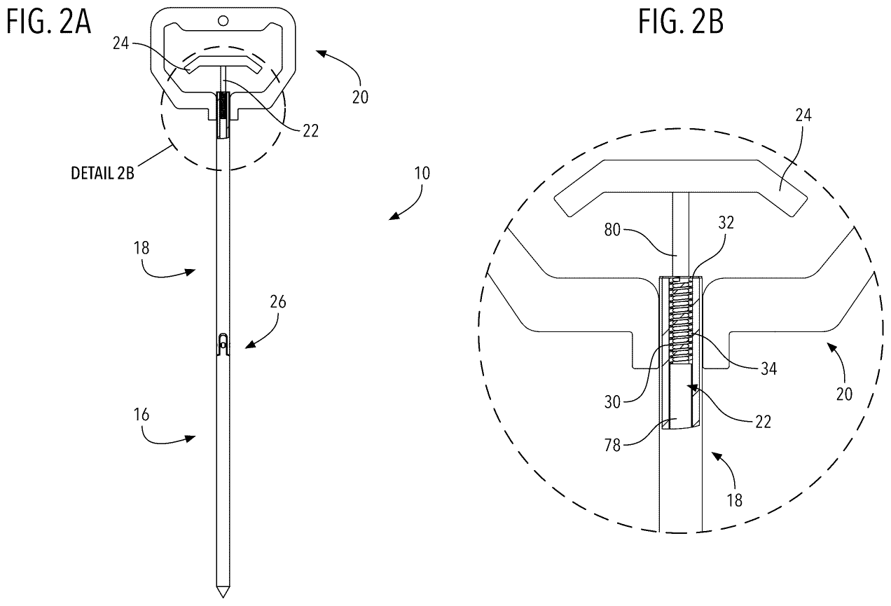

FIG. 2A is a front elevational view of the device shown in FIGS. 1A and 1B;

FIG. 2B is an enlarged partial cross-sectional view taken from DETAIL 2B in FIG. 2A;

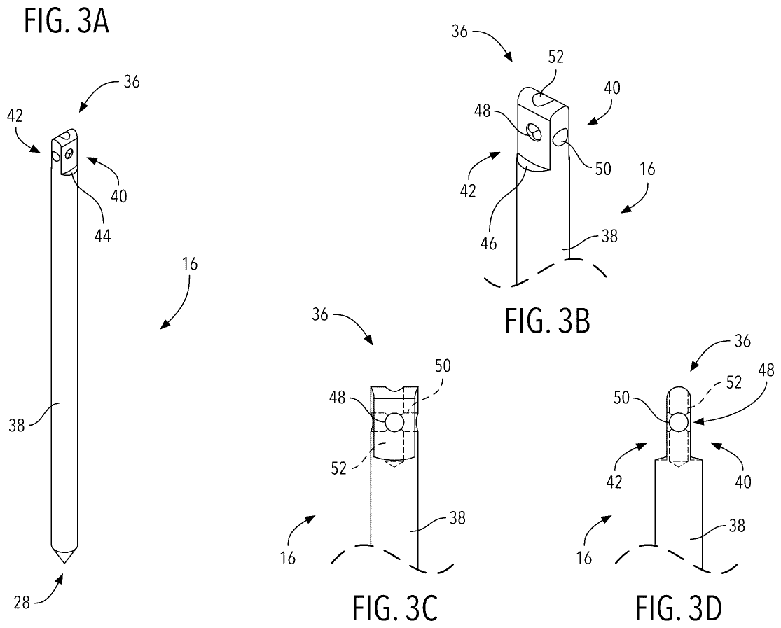

FIGS. 3A through 3D illustrate various views of a distal portion of the device shown in FIG. 2A;

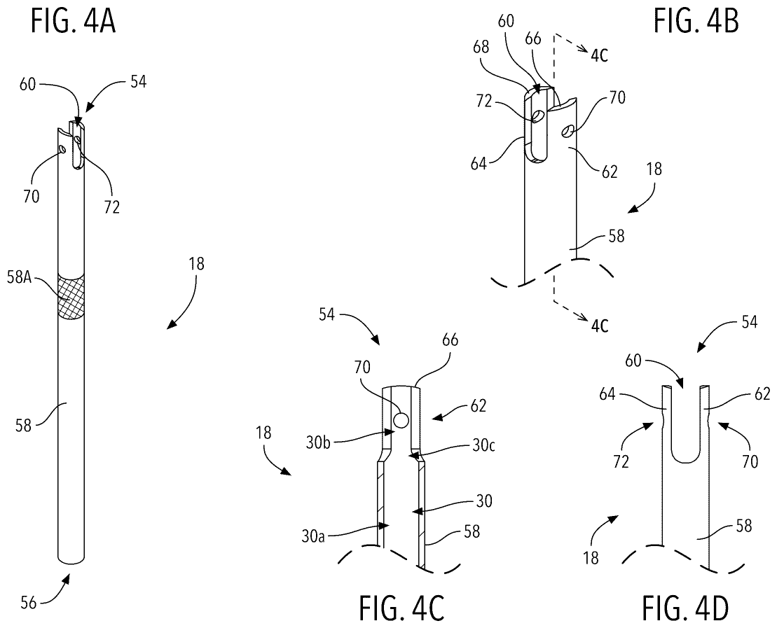

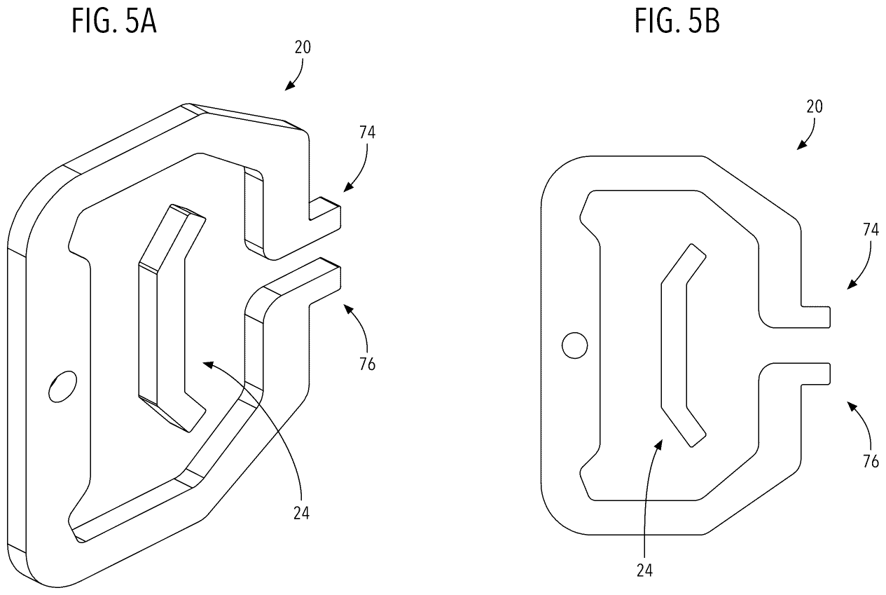

FIGS. 4A through 4D illustrate various views of a proximal portion of the device shown in FIG. 2A;

FIGS. 5A and 5B illustrate a handle portion of the device shown in FIG. 2A;

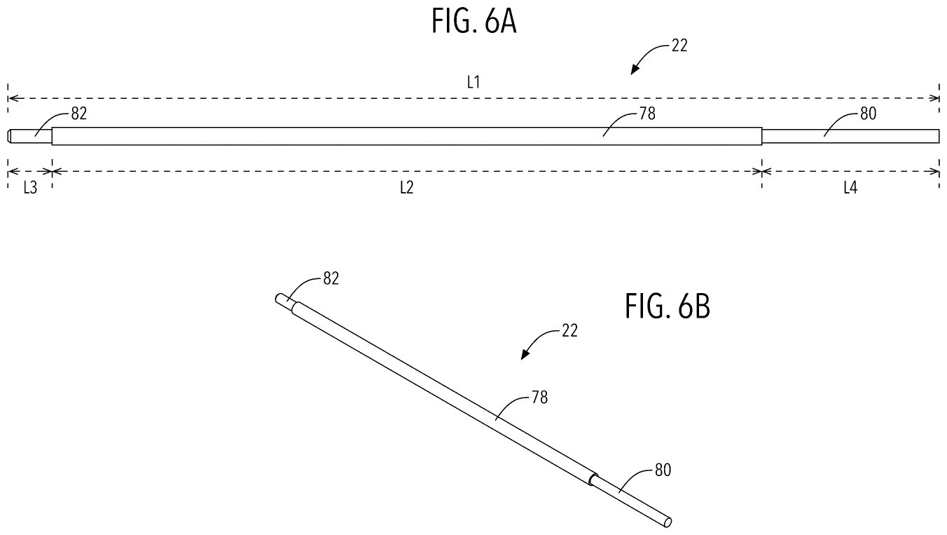

FIGS. 6A and 6B illustrate an internal portion of the device shown in FIG. 2A;

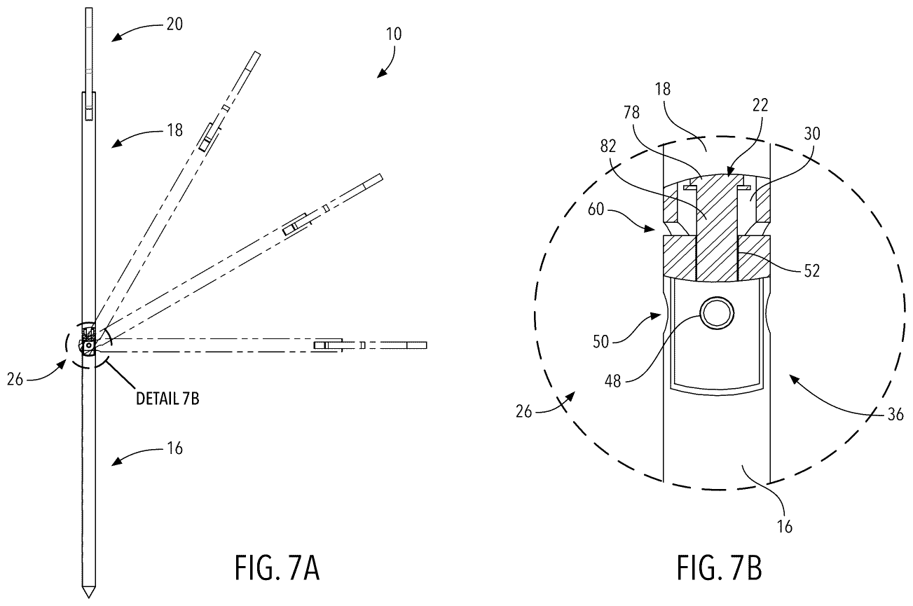

FIG. 7A illustrates movement of the device shown in FIG. 2A;

FIG. 7B is an enlarged view taken from DETAIL 7B in FIG. 7A;

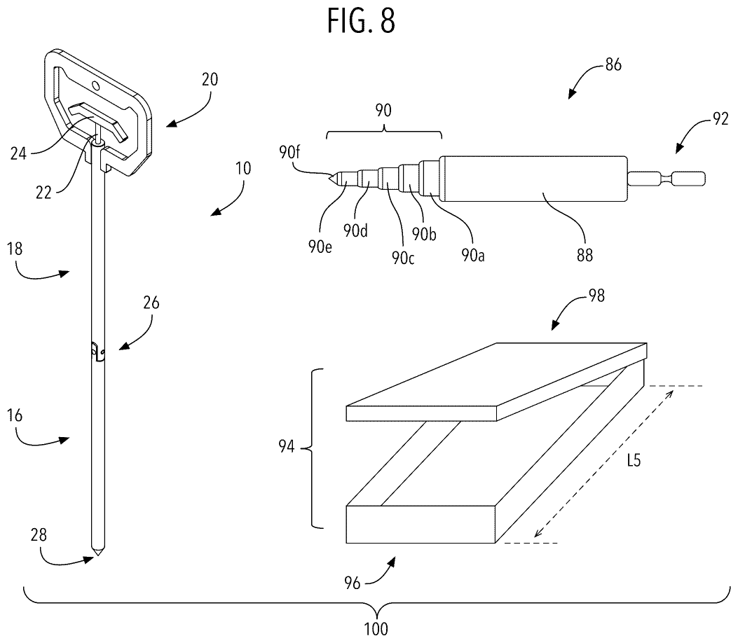

FIG. 8 illustrates additional accessories for door opening device kit including the device shown in FIG. 2A;

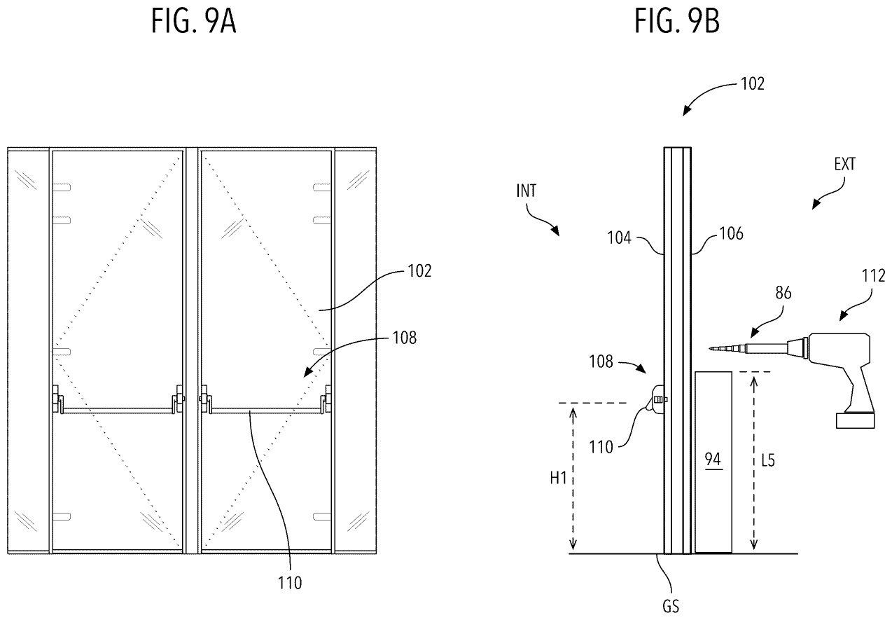

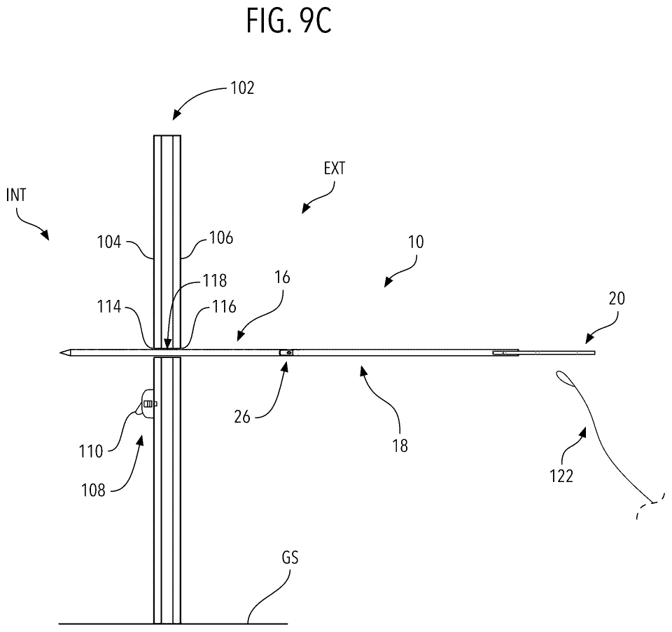

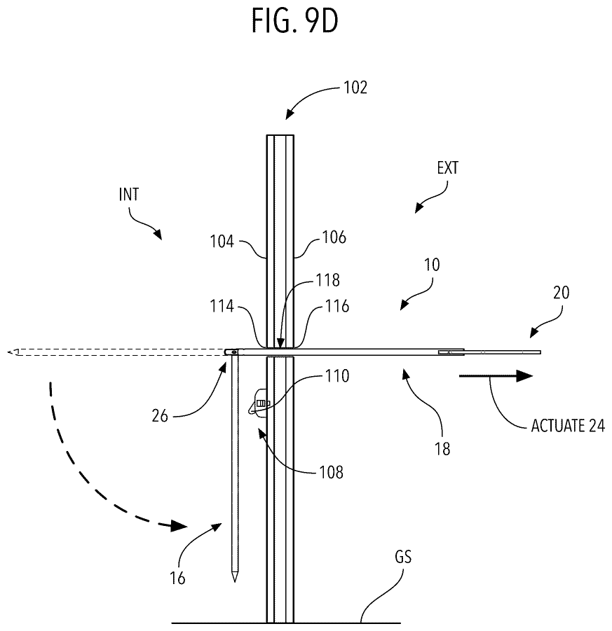

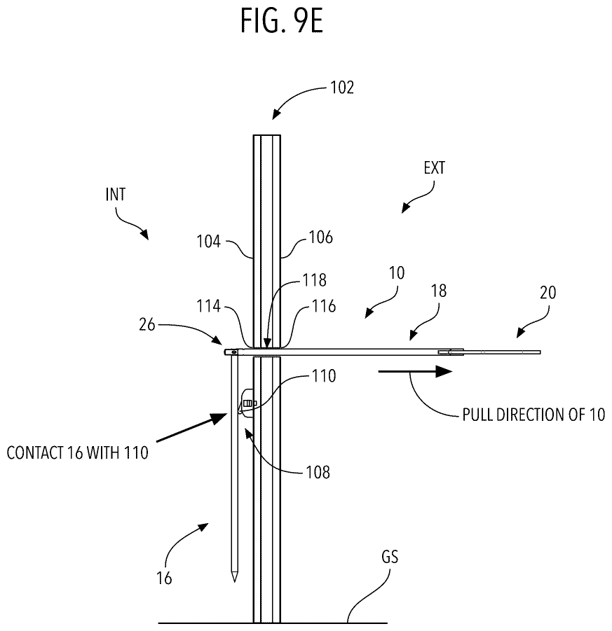

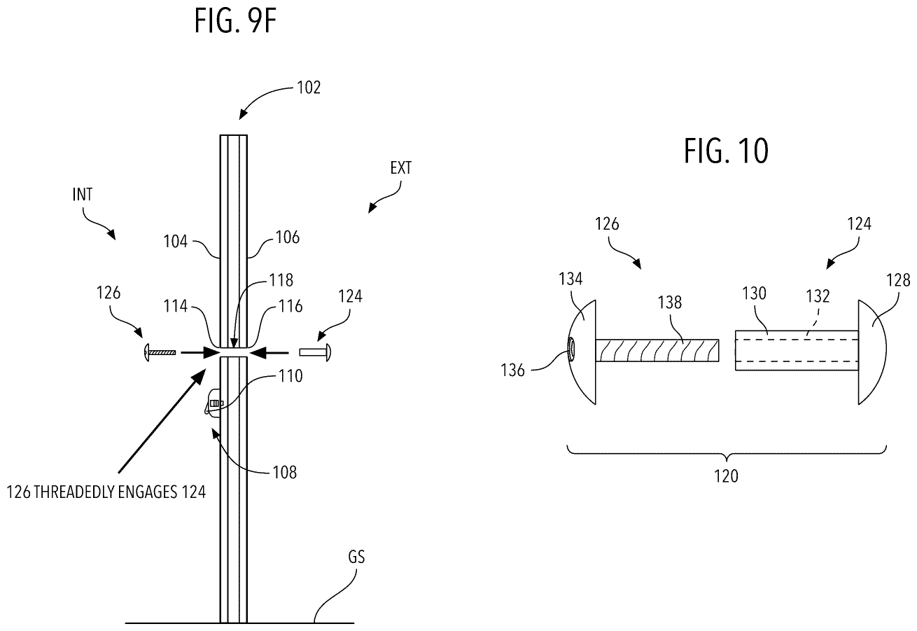

FIG. 9A illustrates an embodiment of a public door having a panic bar;

FIGS. 9B through 9F illustrate a method of using one or more of the door opening device shown in FIG. 2A or the kit shown in FIG. 8, on the public door shown in FIG. 9A; and,

FIG. 10 illustrates an exploded view of a sealing device of the kit shown in FIG. 8.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and, as such, may, of course, vary. It is also understood that the terminology used herein is for the purpose of describing particular aspects only and is not intended to limit the scope of the claims.

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

Adverting now to the figures. Generally, the preferred embodiment of the present invention provides for a door-opening device, e.g., door-opening device 10, that can quickly breach a public door with an interior panic bar with minimal damage and easy repair which eliminates the need to replace the door after the breach.

In reference to FIGS. 1A and 1B, door-opening device 10 (hereinafter “device 10”) comprises an elongated shaft or bar between tip end 12 and handle end 14, where the elongated shaft or bar is formed by distal section 16 and proximal section 18. Distal section 16 includes tip 28 disposed at tip end 12. Tip 28 is preferably a sharpened pointed tip. Proximal section 18 includes handle 20 generally defining handle end 14 where handle 20 is fixedly secured to proximal section 18. Hinged connection 26 hingedly connects distal section 16 to proximal section. Disposed within the elongated shaft, specifically within proximal section 18, is plunger 22 which is designed to selectively engage, via actuation of trigger 24, hinged section 26, allowing distal section 16 to hinge, as generally depicted in FIG. 1B. The configuration of device 10 depicted in FIG. 1A is a “straight-bar” configuration, i.e., distal section 16 and proximal section 18 are colinear about a longitudinal axis, locked by plunger 22 contact with hinged connection 26 within proximal section 18. The “straight-bar” configuration of device 10 is “ready-for-use” or for storage/transportation. The configuration of device 10 depicted in FIG. 1B is a “bent-bar” configuration, i.e., distal section 16 is hinged approximately 90° about hinged connection 26 and relative proximal section 18. Upon actuation of trigger 24, e.g., a pull in a direction towards handle end 14, plunger 22 within proximal section 18 disengages hinged connection 26, allowing distal end 16 to hinge, and once distal end 16 has hinged approximately 90°, a release of trigger 24 will reengage plunger 22 with hinged connection 26, locking device 10 in the “bent-bar” configuration. The “bent-bar” configuration of device 10 is an in-use configuration, i.e., during the process of breaching/opening a locked public door having panic hardware from the outside of the door.

FIGS. 2A and 2B show partial sectional views of door-opening device 10. More specifically, FIG. 2A provides a longitudinal, partial sectional view of the assembled device 10, while FIG. 2B, provides an enlarged, cross-sectional view of the handle end 14 of device 10, taken from DETAIL 2B in FIG. 2A. In a preferred embodiment, proximal section 18 of the elongated shaft of device 10 is substantially a hollow tube with internal cavity 30 formed therein. It should be noted that the term “tube” is not restricted to a cylindrical cross-section, and other possible shapes, e.g., square, triangular, rectangular, elliptical, polygonal, etc., are contemplated within the scope of the appending claims. Internal cavity 30 allows for the housing and operation of plunger 22 and compression spring 34.

FIG. 2A shows door-opening device 10 comprising handle 20, trigger 24, plunger 22 (shown partially), proximal section 18, hinged connection 26 (shown partially and comprised of connections ends 36 and 54, described infra), and distal section 16. It should be noted that handle 20 may be ergonomically designed to provide a comfortable and secure grip during use. Additionally, handle 20 may include textured surfaces or contours to enhance grip and prevent slippage. Distal section 16 and proximal section 18 may be made from a strong, lightweight material such as hardened steel or aluminum alloy, however those in the art will understand that any suitable material, now known or hereafter developed, may be used in forming the present invention described herein.

As described above in view of FIGS. 1A and 1B, and shown in FIG. 2B, plunger 22 is spring-loaded to selectively engage hinged connection 26. This spring loading design ensures that device 10 defaults to a locked configuration, either the straight-bar or the bent-bar configuration. Specifically, as shown in FIG. 2B, compression spring 34 is disposed within internal cavity 30 around trigger portion 80 of plunger 22, biased between one or more of washer 32 or a shoulder formed on trigger portion 80. Washer 32 is preferably disposed at an opening of internal cavity 30 proximate handle 20. Trigger portion 80 of plunger 22 has a smaller diameter than main body 78 of plunger 22, creating an annular space within internal cavity 30 for receiving compression spring 34 (detailed further, infra). In certain embodiments, washer 32 may be made of a durable, low-friction material such as nylon or Teflon to facilitate smooth movement of plunger 22 within internal cavity 30, however, washer 32 is not restricted to a specific material type. Compression spring 34 biases plunger 22 towards hinged connection 26 (specifically, connection end 54 of proximal section 18, shown in FIGS. 3B and 3C) ensuring that a locking portion of plunger 22 (an end of plunger 22 opposite trigger portion 80) engages either a locking aperture or a locking through-bore of hinged connection 26 (shown in FIGS. 3B and 3C of distal section 16).

Trigger 24 is shown extending from handle 20. Plunger 22 is operatively connected to trigger 24, such that actuation of trigger 24 translates plunger 22 within internal cavity 30 against the bias of compression spring 34. This translation of plunger 22 allows for selective disengagement and engagement of locking portion 82 of plunger 22 with the corresponding locking feature (locking aperture 52 or locking through-bore 50 shown in FIGS. 3A-3D) of distal section 16. Hinged connection 26, shown in FIG. 2A, is disposed between distal section 16 and proximal section 18 and generally includes the aforementioned locking feature.

FIGS. 3A through 3D generally illustrate distal section 16 of the door-opening device of the present invention. FIG. 3A shows a perspective view of distal section 16 isolated from the door-opening device and FIGS. 3B-3D show enlarged views of one of the respective ends of distal section 16, e.g., connection end 36.

In a preferred design, distal section 16 comprises connection end 36, tip 28 and shaft body 38 extending therebetween. Connection end 36 is adapted to hingedly connect to the proximal section, described supra. Tip 28 is disposed at the distal-most end of distal section 16, opposite connection end 36. Tip 28 is shown as pointed, which allows for easier insertion of distal section 16 through a hole drilled in a public door. The pointed shape of tip 28 concentrates force at a small contact area, facilitating penetration through the hole drilled in the public door should the public door have material, e.g., insulation, etc., disposed between respective outer faces. Shaft body 38 defines the portion of distal section 16 between connection end 36 and tip 28. As shown in FIG. 3A, shaft body 38 may have a constant diameter, however, other embodiments are contemplated where the diameter of shaft body 38 varies along its length.

Referring now to FIG. 3B, a close-up view of connection end 36 of distal section 16 is shown. Connection end 36 includes a pair of notches 40 and 42, which together define pin through-bore 48 therebetween. Notches 40 and 42 are mirror images of each other about a central plane and each generally have a planar face. Locking aperture 52 is disposed within connection end 36 and is adapted to receive locking portion 82 of plunger 22 therein (See FIG. 6B) when the door-opening device is configured as a straight-bar. Locking through-bore 50 is also disposed within connection end 36, perpendicular to pin through-bore 48 and locking aperture 52 and is also adapted to receive locking portion 82 of plunger 22 therein (See FIG. 6B) when the door-opening device is configured as a bent-bar.

FIGS. 3C and 3D both are an enlarged, partial view of connection end 36 of distal section 16. Through-bore 50 is shown extending completely through connection end 36. Connection end 36 also includes a pair of arches 44 and 46, which bifurcate shaft body 38 and notches 44 and 46. Arches 44 and 46 provide structural support to connection end 36 and may also serve as visual or physical guides during assembly or use. Notches 40, 42, arches 44, 46, pin through-bore 48, locking aperture 52 and locking through-bore 50 are all features of connection end 36.

FIGS. 4A through 4D generally illustrate proximal section 18 of the door-opening device of the present invention. FIG. 4A shows a perspective view of proximal section 18 isolated from the door-opening device, FIGS. 4B and 4D show enlarged partial views of one of the respective ends of proximal section 18, e.g., connection end 54, and FIG. 4C is a cross-sectional view taken generally along line 4C-4C in FIG. 4B. Proximal section 18 includes connection end 54, proximal end 56, and shaft body 58 therebetween. Connection end 54 is adapted to hingedly connect to connection end 36 distal section 16, as described supra. Proximal end 56 is adapted to connect to handle 20, as generally depicted in FIGS. 1A and 1B. Shaft body 58 defines the portion of proximal section 18 between connection end 54 and proximal end 56. Internal cavity 30 extends within shaft body 58 from connection end 54 to a point adjacent proximal end 56.

As shown in FIG. 4A, indicia 58A may be present on shaft body 58. Indicia 58A serves as an indicator the represents a failed contact with a panic bar of a public door. During use of the door-opening device (generally shown in FIGS. 9B through 9E), if the distal section of the door-opening device does not contact the panic bar of the public door, proximal section 18, when the door-opening device is pulled away from the door, proximal section 16 will reveal indicia 58A, through a breach through-bore, thereby indicating a failed breach attempt. As such, indicia 58A is arranged on shaft body 58 at a distance from connection end 54 that respectively corresponds to less than a width of a panic bar's extension from the public door and the width of the door itself and variable according to the specification of selected public doors with panic bars. Such width may also be defined by ADA codes.

FIG. 4B shows an enlarged partial view of connection end 54 of proximal section 18. Connection end 54 includes slot 60 formed between extensions 62 and 64. Pin apertures 70 and 72 are disposed within respective extensions 62 and 64. Ends 66 and 68 of connection end 54 are shown on respective extensions 62 and 64. It should be noted that ends 66 and 68 are preferably arcuate in a manner that is complimentary with the arcuate configuration of arches 44 and 46 of connection end 36 of distal section (See FIGS. 3A and 3B), thereby allowing ends 66 and 68 to freely slide along arches 44 and 46 when abutting.

FIG. 4C is a cross-sectional view of proximal section 18, taken generally along line 4C-4C in FIG. 4B. Internal cavity 30 is shown comprising main portion 30A, distal portion 30B and transition portion 30C therebetween. As can be appreciated, distal portion 30B of internal cavity 30 is the portion of internal cavity 30 disposed within connection end 54. Main portion 30A of internal cavity 30 defines the largest diameter of internal cavity 30 and extends from distal portion 30B to a point adjacent proximal end 56. Transition portion 30C of internal cavity 30 defines the transition in shape and diameter between main portion 30A and distal portion 30B. Generally, distal portion 30B of internal cavity 30 is designed to accept the locking portion of the plunger therein.

FIG. 4D shows a close-up, end view of connection end 54 of proximal section 18. Slot 60 is shown defined between extensions 62 and 64. Pin apertures 70 and 72 are disposed within extensions 62 and 64, respectively and are adapted to receive a pin therein (e.g., pin 84 shown in FIG. 8B). As will be appreciated, pin apertures 70 and 72 are shown as extending completely through extensions 62 and 64.

FIGS. 5A and 5B illustrate handle 20 of the present invention, in perspective and top plan views, respectively. Handle 20 is shown having protrusions 74 and 76, and trigger 24. Protrusions 74 and 76 are adapted to be fixedly secured to proximal section 18 of door-opening device 10, specifically affixed to an outer surface thereof. Trigger 24 is connected to plunger 22 and is adapted to selectively disengage and engage hinged connection 26, as described above. In certain embodiments, handle 20 may be made from a high-strength polymer or metal, or of the same material of the elongated shaft of the present invention, however, material choice of handle 20 should not be considered restrictive on the scope of the appending claims. The shape and size of handle 20 may be ergonomically designed to provide a comfortable and secure grip for the user, even when wearing gloves. Protrusions 74 and 76 may be configured to interlock with corresponding features on proximal end 56 of proximal section 18, such as a recess or channel, to enhance the secure attachment of handle 20. This secure attachment may be further reinforced by the use of adhesives, screws, welding, or other suitable fastening methods. Trigger 24 is preferably positioned and shaped to allow for easy actuation by the user's thumb or fingers. The range of motion of trigger 24 may be limited by a stop or other mechanism to prevent over-travel and ensure consistent engagement and disengagement of hinged connection 26. The surfaces of handle 20 may be textured or coated to improve grip and prevent slippage during use. A lanyard or tether may be attached to trigger 24 to allow actuation at a distance away from handle 20.

FIGS. 6A and 6B illustrate plunger 22 of the present invention, in a side elevation view and a perspective view, respectively. Plunger 22 includes main body 78, locking portion 82, and trigger portion 80. Locking portion 82 is adapted to selectively engage connection end 36 of distal section 16 to maintain elongated pivotable shaft 10 either in a straight or bent configuration, shown in FIGS. 1A and 1B, respectively. Trigger portion 80 is fixedly secured to handle 20 at a terminating end thereof and translates plunger 22 within internal cavity 30 of proximal section 18, thereby disengaging and engaging locking portion 82 with distal section 16. Main body 78 defines the portion of plunger 22 between locking portion 82 and trigger portion 80. As shown in FIG. 6A, L1 represents the overall length of plunger 22; L2 represents the length of main body 78; L3 represents the length of locking portion 82; and L4 represents the length of trigger portion 80. These lengths may be designed such that they have a ratio of approximately L1:L2:L3:L4=8:4:1:3. It should be understood that this ratio is exemplary, and other ratios are contemplated.

Trigger portion 80 is shown having a reduced diameter relative to main body 78. This reduced diameter allows for compression spring 34 to be fitted onto trigger portion 80, as best shown in FIG. 2B. The spring biases plunger 22 towards the distal section, ensuring that the locking portion 82 engages with the connection end of the distal section. The dimensions of plunger 22, specifically lengths L1-L4, may be selected to ensure proper engagement and disengagement with the locking features of the distal section and to provide sufficient travel for reliable operation of the hinged connection (i.e., the hinging mechanism). Locking portion 82 may include a beveled or tapered end to aid in its engagement with locking aperture 52 or locking through-bore 50 of distal section 16.

FIGS. 7A and 7B illustrate the interaction between plunger 22 and hinged connection 26, which facilitates the hinging action of door-opening device 10. FIG. 7A depicts the relative positions and movements of the components involved in the hinging mechanism of device 10. FIG. 7B, taken generally from DETAIL 7B in FIG. 7A, presents an enlarged partial cross-sectional view of hinged connection 26, focusing on the engagement of plunger 22 in the locked position specifically the locked position of the straight-bar configuration of device 10.

As shown in FIG. 7A, door-opening device 10 comprises distal section 16, hinged connection 26, proximal section 18, and handle 20. This view illustrates the movement of distal section 16 relative to proximal section 18 about hinged connection 26. The dashed lines indicate the range of motion of distal section 16, pivoting between a straight-bar configuration (where distal section 16 and proximal section 18 are aligned) and a bent-bar configuration (where distal section 16 is at an angle to proximal section 18). The degree of bending, typically around 90°, is determined by the geometry of the locking features and the travel of plunger 22. Handle 20 remains fixed to proximal section 18, providing a stable grip for the user during operation.

FIG. 7B, provides a magnified view of the locking mechanism within hinged connection 26. Connection end 36 of distal section 16 includes locking aperture 52 and pin through-bore 48. Proximal section 18 features connection end 54 with slot 60 defined between the extensions, described supra, along with their pin apertures. Plunger 22, housed within internal cavity 30 of proximal section 18, includes main body 78 and locking portion 82. Trigger portion 80 of plunger 22, connected to trigger 24 (shown in FIG. 7A), is not visible in this cross-section. When device 10 is in the locked position, locking portion 82 of plunger 22 is fully inserted into locking aperture 52 of distal section 16 (or with the locking through-bore). This engagement prevents relative movement between distal section 16 and proximal section 18. Pin 84, passing through pin apertures 70 and 72 of proximal section 18 (See FIGS. 4A-4D) and pin through-bore 48 of distal section 16, secures the two sections together while allowing for rotational movement when the plunger is disengaged.

To initiate hinging, the user actuates trigger 24 (See FIGS. 1A and 1B), translating plunger 22 within internal cavity 30 and retracting locking portion 82 from locking aperture 52. This disengagement allows distal section 16 to rotate relative to proximal section 18 about an axis defined by a center of pin 84. Upon releasing trigger 24, compression spring 34 (shown in FIG. 2B) forces plunger 22 back towards connection end 36, causing locking portion 82 to re-engage with either locking aperture 52 or through-bore 50 (for the bent-bar configuration, as shown in FIG. 1B), thus securing the device in the desired position. The specific locking feature engaged (either locking aperture 52 or through-bore 50) dictates the angle between distal section 16 and proximal section 18, enabling the device to be locked in either the straight-bar or bent-bar configuration.

FIG. 8 illustrates door-breaching kit 100 of the present invention, including door-opening device 10, step bit 86, and container 94. Step bit 86 includes body 88, shank 92, and flute 90. Container 94 comprises main body 96 and lid 98. The length L5 of container 94 serves a dual purpose: accommodating door-opening device 10 therein and providing a height guide for drilling a hole through a public door to be breached. Length L5 is specifically designed to be greater than both the total length of device 10 (allowing it to fit inside) and the typical mounting height of a panic bar on a locked public door. This ensures that when a user positions the top edge of container 94 adjacent and against the door (the bottom surface abutting an external surface of the public door), the resulting drilled hole (using step bit 86) will be above the panic bar, enabling proper engagement of device 10 with the panic bar mechanism—allowing gravity hinge distal section 16 of device 10 downwardly when hinged connection 26 is actuated, thereby increasing speed and efficiency of use.

The combined length of body 88 and flute 90 of step bit 86 is at least as long as the width of a standard public door, ensuring complete penetration during drilling. Flute 90 has a stepped configuration (sections 90A-90F) with increasing diameters from tip 90F to section 90A. The portion of body 88 proximate section 90A has an approximate diameter of 9/16th of an inch. The diameters of flute sections 90A through 90E are approximately ½ inch, 7/16th of an inch, ⅜th of an inch, 5/16th of an inch, and ¼th of an inch, respectively. It should be noted that the aforementioned diameters are exemplary and are variable according to the needs of device 10 and the dimensions of the particular door to be breached. This stepped design, of bit 86, creates a pilot hole and progressively widens the opening, reducing drilling force and door damage. Shank 92 is sized for a standard drill chuck. It should be noted that step bit 86 increases the speed of a breach using kit 100. This is because step bits cut much less metal at a time than a larger bit, so step bits cut faster with less strain on a drill, which in turn saves a lot of time and avoids switching out bits, i.e., a pilot hole bit. Public doors are sometimes hollow, or at least have an internal space between respective faces. These doors made be made of sheet metal or metal, where the use of a non-stepped drill bit or standard sized drill bit may create burs that can slow the penetration of device 10 through the door, or a standard sized drill bit will deform the metal if it grabs during drilling, thereby slowing the breaching process. Utilizing step bit 86 eliminates these issues.

The following description should be taken in view of FIGS. 9A through 9F, which illustrate the steps in using door-breaching kit 100 to open public door 102. FIG. 9A provides a representative view of public door 102, highlighting panic hardware 108 and panic bar 110. FIG. 9B demonstrates the process of drilling a breach through-bore in public door 102 using step bit 86 and drill 112, guided by the length L5 of container 94. Public door 102 is shown having interior surface 104 and exterior surface 106. Panic hardware 108 is affixed to interior surface 104 of door 102. Panic bar 110 is shown attached to panic hardware 108.

As shown in FIGS. 9B and 9C, the first step in using kit 100 involves drilling a breach through-bore 118 in public door 102. Container 94 is positioned against exterior surface 106 of door 102, such that length L5 of container 94 is aligned vertically along door 102 and above panic hardware 108. The top edge of container 94 acts as a height guide, ensuring that breach through-bore 118 is drilled above panic bar 110 at height H1. Drill 112 is shown having step bit 86 chucked therein. Step bit 86 is used to drill breach through-bore 118, which will subsequently accommodate door-opening device 10. The length L5 of container 94 ensures that breach through-bore 118 is positioned above panic bar 110, typically at a height H1 that corresponds to the desired location for engaging the panic hardware mechanism. Ground surface GS is shown below door 102.

FIG. 9C illustrates the next step in the door breaching process using kit 100, following the drilling of breach through-bore 118 in FIG. 9B. Door-opening device 10 is inserted through breach through-bore 118 in public door 102. Device 10 is shown in the straight-bar configuration, with distal section 16 extending through door 102 towards interior surface 104. Proximal section 18, handle 20, and optionally tether 122 which may be attached to the trigger, remain on the exterior side of door 102. Hinged connection 26 is located near the exterior surface 106 of the door. Breach apertures 114 and 116, drilled in the previous step (FIG. 9B), are visible and define breach through-bore 118. Panic hardware 108 and panic bar 110 are shown on the interior side of the door. The purpose of this step is to position device 10 such that distal section 16 can engage panic bar 110 and actuate the panic hardware, allowing the door to be opened from the outside. Tether 122 may be attached to handle 20, preferably the trigger) or any other suitable location on device 10 to allow actuation of the trigger at a distance away from door 102.

FIG. 9D illustrates the subsequent step in the door breaching process, following the insertion of door-opening device 10 through breach through-bore 118 (as shown in FIG. 9C). In this step, trigger 24 (not shown) of handle 20 is actuated on the exterior side (EXT) of public door 102. Actuating trigger 24 disengages plunger 22 (not shown) from distal section 16, allowing distal section 16 to pivot about hinged connection 26. As shown by the dashed arrow, distal section 16 pivots downwards towards panic bar 110. Door-opening device 10 is shown having distal section 16 generally aligned with and proximate panic bar 110, which is attached to panic hardware 108, affixed to the interior surface (INT) of public door 102. Proximal section 18 and handle 20 are shown on the exterior side of door 102. Apertures 114 and 116, from the drilling step (FIG. 9B), are also visible. This pivoting action positions distal section 16 for engagement with panic bar 110, which is the next step in the breaching process. The downward pivoting motion of distal section 16 is controlled by the user (via unlocking hinged connection 26), who applies a pulling force on trigger 24 in the direction away from exterior surface 106 of door 102. This action brings distal section 16 proximate to panic bar 110, preparing for the final actuation of the panic hardware.

FIG. 9E shows the next stage in the door breaching process using kit 100. Following the steps illustrated in FIGS. 9B through 9D, distal section 16 is now positioned to engage panic bar 110. As the user continues to pull handle 20 of door-opening device 10 in the direction away from exterior surface 106, distal section 16 makes contact with panic bar 110, transferring the pulling force to the panic hardware mechanism. This force effectively depresses panic bar 110, simulating the action of someone pressing the bar from the interior side (INT) of public door 102, thereby opening door 102 from the interior side (INT). This action initiates the unlocking of panic hardware 108, preparing to open public door 102.

FIG. 9F illustrates the final step in the door breaching process and a subsequent “clean-up” step using door-breaching kit 100. After the door has been opened, door-opening device 10 is removed, and a sealing device (comprised of outer cover 124 and inner cover 126), which may be a component of door-breaching kit 100, is inserted into breach through-bore 118. Outer cover 124 is designed to fit snugly within breach through-bore 118, covering the opening (e.g. 116) and restoring a closed exterior side (EXT) of public door 102. Inner cover 126 is then inserted into breach through-bore 118, covering the opening (e.g., 114) and is threadedly engaged within outer cover 124. This clean-up step helps to mitigate potential hazards posed by the open through-bore, making the area “safe” for first responders and others, such that they may now depart from the building and/or area. Preferably, covers 124 and 126 are made of a durable and rigid material to prevent access after installation, e.g., metals. In certain embodiments, covers gasket 124 and 126 may be color-matched to public door 102 for a more aesthetically pleasing appearance after breaching. This final step completes the door breaching process and leaves the area safe and secure.

With reference to FIGS. 9F and 10, FIG. 10 illustrates sealing device 120, which may be a component of door-breaching kit 100. Sealing device 120 includes outer cover 124 and inner cover 126 which are designed to be threadably secured to each other within a breach through-bore of a public door. (See FIG. 9F, generally). Outer cover 124 is comprised of head 128 having shaft 130 extending therefrom. Shaft 130 has threaded through-bore 132 arranged therein, where threaded through-bore 132 is closed proximate head 128 and open opposite head 128. Inner cover 126 is comprised of head 134 having threaded shaft 138 extending therefrom. Head 134 also includes drive 136 arranged therein, where drive 136 may be designed as any number bit-configurations. Threaded shaft 138 is complimentary to threaded through-bore 132 of outer cover 124, such that it may be threadably engaged therein. This configuration allows the respective planar sides of heads 128 and 134 of covers 124 and 126, respectively, to flushly abut surfaces 104 and 106 of door 102 when threadably connected, thereby covering breach through-bore 118 and its openings 114 and 116.

In reference to all of the Figures, in some embodiments, the present invention may comprise a kit (100) for opening a locked public door (102) with an interior panic bar (110) from the outside of the public door, the kit including: A) a door-opening device (10) comprising an elongated pivotable shaft having a handle (20) with a trigger (24) disposed at a first end (14) and a tip (28) disposed at a second end (12), the pivotable shaft comprising: a proximal section (18) connected to the handle (20) and having an internal cavity (30); and, a distal section (16) having the tip (28), the proximal section (18) hingedly connected (via 26) to the distal section (16) opposite the handle (20) and the distal section (16) hingedly connected (via 26) to the proximal section (18) opposite the tip (28); a plunger (22) arranged within the internal cavity (30) and connected to the trigger (24), the trigger (24) adapted to selectively translate the plunger (22) within the internal cavity (30) to engage or disengage the distal section (16) to allow the distal section (16) to pivot about the proximal section (18); B) a step drill bit (86) having a multi-diameter flute (90); C) a rigid case (94); and optionally, D) a sealing device (120) adapted to fill a breach through-bore (118) made in the public door (102).

The invention illustratively disclosed herein suitably may be practiced in the absence of any element which is not specifically disclosed herein. It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Door-opening device
12 Tip end
14 Handle end
16 Distal section
18 Proximal section
20 Handle
22 Plunger
24 Trigger
26 Hinged connection
28 Tip
30 Internal cavity
30A Main portion
30B Distal portion
30C Transition portion
32 Washer
34 Compression spring
36 Connection end
38 Shaft body
40 Notch
42 Notch
44 Arch
46 Arch
48 Pin through-bore
50 Through-bore
52 Locking aperture
54 Connection end
56 Proximal end
58 Shaft body
58A Indicia
60 Slot
62 Extension
64 Extension
66 End
68 End
70 Pin aperture
72 Pin aperture
74 Protrusion
76 Protrusion
78 Main body
80 Trigger portion
82 Locking portion
84 Pin
86 Step bit
88 Body
90 Flute
90a Section
90b Section
90c Section
90d Section
90e Section
90f Tip
92 Shank
94 Container
96 Main body
98 Lid
100 Door-breaching kit
102 Public Door
104 Interior surface
106 Exterior surface
108 Panic hardware
110 Panic bar
112 Drill
114 Aperture
116 Aperture
118 Breach through-bore
120 Sealing device
122 Tether
124 Outer cover
126 Inner cover
128 Head
130 Shaft
132 Threaded through-bore
134 Head
136 Drive
138 Threaded shaft
GS Ground surface
EXT Exterior
INT Interior
L1 Length
L2 Length
L3 Length
L4 Length
L5 Length
H1 Height

What is claimed is:

1. A door-opening device adapted to open a locked public door with an interior panic bar from the outside of the public door, the device comprising:
an elongated pivotable shaft having a handle with a trigger disposed at a first end and a tip disposed at a second end, the pivotable shaft comprising:
a proximal section connected to the handle and having an internal cavity; and,
a distal section having the tip, the proximal section hingedly connected to the distal section opposite the handle and the distal section hingedly connected to the proximal section opposite the tip;
a plunger arranged within the internal cavity and connected to the trigger, the trigger adapted to selectively translate the plunger within the internal cavity to engage or disengage the distal section to allow the distal section to pivot about the proximal section.

2. The door-opening device recited in claim 1, wherein:
the proximal section comprising a slot formed by a pair of extensions and being arranged opposite the handle, each of the pair of extensions having a pin aperture therein;
the distal section comprising a connection end defined by a pair of notches and being arranged opposite the tip, the connection end having a pin through-bore disposed between respective faces of the pair of notches; and,
a pin arranged within each of the pin apertures and the pin through-bore to hingedly connect the distal section to the proximal section.

3. The door-opening device recited in claim 2, wherein:
the connection end having a locking aperture disposed therein and arranged perpendicularly to the pin through-bore, the locking aperture arranged to accept a locking portion of the plunger therein, thereby locking the distal section and the proximal section in a straight-bar configuration.

4. The door-opening device recited in claim 3, wherein:
the connection end having a locking through-bore disposed therein and arranged perpendicularly to both the pin through-bore and the locking aperture, the locking through-bore arranged to accept the locking end of the plunger therein, thereby locking the distal section and the proximal section in a 90° angle.

5. The door-opening device recited in claim 2, wherein:
the connection end having a locking aperture disposed therein and arranged perpendicularly to the pin through-bore;
the connection end having a locking through-bore disposed therein and arranged perpendicularly to both the pin through-bore and the locking aperture;
wherein either the locking aperture or the locking through-bore is arranged to accept a locking end of the plunger therein, allowing the pivotable shaft to be selectively oriented in either a straight-bar configuration or a bent-bar configuration, the bent-bar configuration having a 90° angle.

6. The door-opening device recited in claim 1 further comprising:
a spring engaged with the plunger and the internal cavity adapted to bias the plunger within the internal cavity towards the distal section.

7. The door-opening device recited in claim 1 further comprising:
a spring engaged with the plunger and the internal cavity adapted to bias the plunger within the internal cavity towards the distal section,
wherein the plunger comprises a main body having a locking portion extending therefrom and a trigger portion extending therefrom opposite the locking portion, the locking and trigger portions having a diameter being less than a diameter of the main body, wherein the trigger portion is arranged to accept the spring thereon.

8. The door-opening device recited in claim 1 further comprising:
a tether removably attached to the trigger.

9. A kit for opening a locked public door with an interior panic bar from the outside of the public door, comprising:

1. r-opening device recited in claim 1;
a step drill bit having a multi-diameter flute; and,
a rigid case.

10. The kit for opening a locked public door with an interior panic bar from the outside of the public door recited in claim 9, wherein the flute of the step drill bit has an overall length that is greater than an overall width between an interior surface and an exterior surface of the locked public door.

11. The kit for opening a locked public door with an interior panic bar from the outside of the public door recited in claim 9, wherein the rigid case has an overall length that is greater than a mounting height of the interior panic bar on the locked public door.

12. The kit for opening a locked public door with an interior panic bar from the outside of the public door recited in claim 9, wherein one or more of:
the flute of the step drill bit has an overall length that is greater than an overall width between an interior surface and an exterior surface of the locked public door; or,
the rigid case has an overall length that is greater than a mounting height of the interior panic bar on the locked public door.

13. A door-opening device adapted to open a locked public door with an interior panic bar from the outside of the public door, the device comprising:
an elongated pivotable shaft having a handle with a trigger disposed at a first end and a tip disposed at a second end, the pivotable shaft comprising:
a proximal section connected to the handle and having an internal cavity, the proximal section comprising a slot formed by a pair of extensions and being arranged opposite the handle, each of the pair of extensions having a pin aperture therein; and,
a distal section having the tip, the proximal section hingedly connected to the distal section opposite the handle and the distal section hingedly connected to the proximal section opposite the tip, the distal section comprising a connection end defined by a pair of notches and being arranged opposite the tip, the connection end having a pin through-bore disposed between respective faces of the pair of notches;
a pin arranged within each of the pin apertures and the pin through-bore to hingedly connect the distal section to the proximal section; and,
a plunger arranged within the internal cavity and connected to the trigger, the trigger adapted to selectively translate the plunger within the internal cavity to engage or disengage the distal section to allow the distal section to pivot about the proximal section.

14. The door-opening device recited in claim 13, wherein:
the connection end having a locking aperture disposed therein and arranged perpendicularly to the pin through-bore;
the connection end having a locking through-bore disposed therein and arranged perpendicularly to both the pin through-bore and the locking aperture;
wherein either the locking aperture or the locking through-bore is arranged to accept a locking end of the plunger therein, allowing the pivotable shaft to be selectively oriented in either a straight-bar configuration or a bent-bar configuration, the bent-bar configuration having a 90° angle.

15. A kit for opening a locked public door with an interior panic bar from the outside of the public door, comprising:

14.-opening device recited in claim 14;
a step drill bit having a multi-diameter flute; and,
a rigid case.

16. The kit for opening a locked public door with an interior panic bar from the outside of the public door recited in claim 15, wherein the flute of the step drill bit has an overall length that is greater than an overall width between an interior surface and an exterior surface of the locked public door.

17. The kit for opening a locked public door with an interior panic bar from the outside of the public door recited in claim 15, wherein the rigid case has an overall length that is greater than a mounting height of the interior panic bar on the locked public door.

18. The kit for opening a locked public door with an interior panic bar from the outside of the public door recited in claim 15, wherein one or more of:
the flute of the step drill bit has an overall length that is greater than an overall width between an interior surface and an exterior surface of the locked public door; or,
the rigid case has an overall length that is greater than a mounting height of the interior panic bar on the locked public door.

19. A door-opening device adapted to breach a locked public door with an interior panic bar comprising:
an elongated shaft with a break in the center, said elongated shaft have a first end and a second end wherein the first end has a pointed center and said second end has a handle and a lever, the lever extending through an interior portion of the elongated shaft and being spring loaded to either lock or selectably unlock the first end and the break in the center to either lock the elongated shaft as a straight bar or as a bent bar having a 90° angle.

20. A method for breaching a locked public door with an interior panic bar from the outside of the door, the method comprising:
drilling at least one hole through the locked public door, the at least one hole being above the interior panic bar of the door;
inserting the elongated shaft of the door-opening device recited in claim 19 into the at least one hole as the straight bar;
unlocking the lever of the elongated shaft and locking the lever of the elongated shaft into the bent bar;
pulling the elongated shaft away from the door to contact the interior panic bar; and,
applying force onto the interior panic bar to unlock the public door.
